(19) United States
(12) Patent Application Publication
(10) Pub. No.: US 2007/0051208 A1
(43) Pub. Date: Mar. 8, 2007

(54) Nail driving tool

(76) Inventor: John W. Stephens, Friday Harbor, WA (US)

Correspondence Address: JOHN STEPHENS, P.O. BOX 2422, FRIDAY HARBOR, WA, 98250, US

(21) Appl. No.: 11/220,194

(22) Filed: Sep. 6, 2005

(51) Int. Cl. B25C 3/00; B25C 7/00

(52) U.S. Cl. 81/44; 227/147

(57) ABSTRACT

A nail driving tool of extended length for use with a standard carpenters hammer having no moving parts is disclosed for the purpose of placing nails in difficult to access places. Tool provides means on a first planar surface for magnetically retaining and holding a plurality of nail types and sizes in proper alignment for positioning. And, a second planar surface at opposite end of extended nail driving tool arranged to further drive said nails to maximum depth.

### BACKGROUND

This invention relates generally to a nailing extension and more specifically to a heavy duty double ended nail holding, positioning and driving tool; intended to be used with a common carpenters hammer. The disclosed extended ailing tool to be arranged for the placement and diving of various types of large nails and spikes in hard to access places wherein one end of the tool provides for holding and positioning the nail for starting, wherein after the nail is started, the tool is turned end for end wherein the opposite end of the tool is placed on the nail head wherein the operator can drive the nail to the fully seated position.

Persons familiar in the art of construction will understand that it is common procedure when driving a nail to hold the nail between the index finger and the thumb of one hand, set the point of the nail to the position where it is to be driven; keeping the nail perpendicular to the work surface, then striking the head of the nail with a hammer wherein at least the tip or point of the nail enters the work surface to a depth which allows the nail to sustain the erect position perpendicular to the work piece so the index finger and thumb can be removed from the nail. At this point, the operator can continue to strike the head of the nail driving it to its full depth without the risk of accidentally striking the fingers that were previously holding the nail in position. Although this procedure seems fairly straight forward and simple enough, there are a number of obstacles or instances where the procedure can be more complex; such as when the size of the nail to be driven is so small that there is limited room for average sized fingers to grip the nail or hold it in the proper position for receiving the initial strike from a hammer; or when the nail to be driven cannot be positioned and held properly by index finger and thumb in the standard manner; due to lack of space or obstructions in and around the area where the nail is to be driven. The third condition that often presents a problem is when although the size of the nail to be driven is adequate for gripping in the standard manner, allowing sufficient room for the fingers and hand holding the nail in and around the area where the nail is to be driven. There is insufficient room to swing or maneuver a standard hammer in a manner that will allow the operator to contact the head of the nail squarely as required to successfully drive the nail into a surface completely. There have been any number of attempts to provide solutions for the referenced problems involving the retaining, positioning and driving of nails in hard to access or confined spaces. However, although prior art works have defined some innovative approaches the element of versatility, compactness and operational simplicity as disclosed in the present invention has not been addressed in any one single prior artwork.

The “Nail Holding and Directing Device”, U.S. Pat. No. 4,403,725 granted to Lawrence outlines a device arranged to hold, and direct a nail to the location where it will be driven wherein the nail is held by a set of mechanical fingers activated by the operators thumb from a handle which protrudes from the nail holding portion of the device. In terms of providing a solution for the second obstacle which addresses limited access around or near the nailing surface, this device would fall short in many situations as it would actually require more space to accommodate the device with it's protruding handle as well as the operators hand.

Martinez's U.S. Pat. No. 4,829,855 “Magnetic Nail Holding Device” outlines a tool arranged to grip a nail with magnetic fingers allowing the user to keep fingers a safe distance from the impact area of the hammer. It would also enable one to hold a mush smaller nail than might be possible with the standard “index finger, thumb” method. Although this tool is innovative utilizing a magnetic component to assist in holding the nail, and would certainly be useful at times, it does not provide for working in limited access spaces where there might be little room for the operators hand, or, provide any function to assist in the actual driving of the nail fully into the work piece

Mr. Falls “Nail Starter” as outlined in U.S. Pat. No. 4,667,747 is yet another device aimed at providing a solution for at least part of the nail starting problem. Again a magnet is employed to retain the nail in the proper attitude for getting it started while keeping the operators fingers clear of the impact area. This device however is not intended for and does not address the particular problems encountered when attempting to dive nails in restricted or confined areas.

U.S. Pat. No. 4,967,623 issued to Linda K Jackson falls into a similar category as the works outlined above, as again the primary objective does not seem target the “limited space” problem. Again, magnets are used to retain the nail on the device in the desired attitude for positioning and starting however no provision is offered that would enhance ones ability for continued access to the nail head with a hammer in a limited access situation.

A different approach, which is more direct in addressing the limited access issue, is the works outlined in Mr. Williams “Axial Impact Tool”. U.S. Pat. No. 4,299,021 wherein an axial impact device is disclosed featuring a guide tube consisting of an extended tubular section for housing a sliding rod. The sliding rod is equipped with a magnetic component on one end for retaining the nail or fastener and a weighted handle at the opposite end for providing the driving force required to sink the nail into a substrate surface. There is no doubt that Mr. William's idea has merit within the confines of relatively light work such as driving small nails or staples. His device also addresses the problems associated with accessing confined spaces. The shortcomings however compared to the present invention present themselves wherein the sliding member required to provide the impact force required to actually drive a nail into a substrate is limited to the weight of the handle and the velocity one can achieve in sliding the handle and impact rod through the guide tube to provide the driving force compared to a common hammer with a handle arranged to multiply that force. This of course is a limitation inherent in most tools that incorporate the means for providing impact as an integral part of the driving tool.

A similar work, U.S. Pat. No. 3,036,482 was granted to Mr. Kenneth Kenworthy in 1962. Mr. Kenworthy's device is also an axial impact type tool and although he outlines its ability to be fitted with a plurality of end pieces for a number of applications, the shortcomings are basically the same as outlined for Mr. Williams work. It is also important to note that in the relatively hostile environment of many construction sights where tools of this type might be used, overall ruggedness, durability and simplicity is important in their design. It would be questionable whether either of the two devices disclosed in the last two referenced patents would fare well in a more harsh construction environment due to the inclusion of multiple threaded attachments required to make them functional and the fact that even slight bending or denting of their outside guide tubes would cause the sliding rod to bind rendering them useless.

### SUMMARY OF THE INVENTION

In view of the disadvantages outlined relative to prior art nail retaining, positioning, and driving tools, the present invention provides for simple and inexpensive tool comprised of an extended length of solid hardened steel bar stock capable of transmitting impact force from the strike of a common carpenters hammer to the head of a nail. Each of the two ends of the hardened steel tool are provided for with an impact surface. One end of the tool as disclosed is defined as being the second planar surface wherein a bore within the second planar surface provides means for receiving and retaining a plurality of nail types and sizes utilizing magnetic attachment. A portion of the second planar surface is also arranged to accommodate an impacting blow from a hammer. The opposite end of the extended nail retaining positioning and driving tool is defined as the first planar surface. The first planar surface is also provided to accommodate an impacting blow from a common hammer. A typical application for the disclosed tool would be the driving of a nail into a surface that may not allow room to swing a hammer in the normal manner wherein the operator would place the head of the selected nail into the bore of the second planar surface where it would be retained by the magnet. The extended tool would then be manipulated whereby the point of the nail would be positioned as required inside the restricted area wherein the first planar surface of the tool would be extended outside the area mentioned that would not allow the swinging of a hammer. The operator would then strike the first planar surface with a hammer using only enough force to partially drive the nail or; keep the nail in position. The tool would then be retracted and turned end for end wherein the first planar surface would be pressed substantially against the nail head and the second planar surface would be accessible outside the restricted area. The operator would then strike the second planar surface of the extended nailing tool as required to completely and properly drive the nail to its final position

It is an objective of the disclosed invention to disclose a tool of extended length providing for the placement and driving of nails in areas where there is either limited space to position the nail for starting, limited space to swing a hammer, or obstructions in or around the area where the nail is to be driven that would inhibit either function.

It is yet another objective to disclose single piece extended length; nail holding, positioning and driving tool arranged to utilize both end surfaces in achieving all three of the aforementioned functions of holding a nail, positioning a nail and driving a nail.

Another objective of the tool is to provide a nail holding, positioning and driving device arranged with a means for retaining the nail in a centered and properly oriented position for driving.

A final objective of the present invention is to disclose an inexpensive one piece heavy duty tool for use with a common hammer; that is compact in size, extremely rugged for use in harsh or dirt contaminated areas, devoid of moving parts, and able to accommodate a plurality of nail types and sizes.

The aforementioned objectives of the present invention will become apparent upon reviewing the following detailed description and referencing the accompanying drawings wherein similar characters of reference represent corresponding parts in each of the several views.

Referring now to the drawings wherein

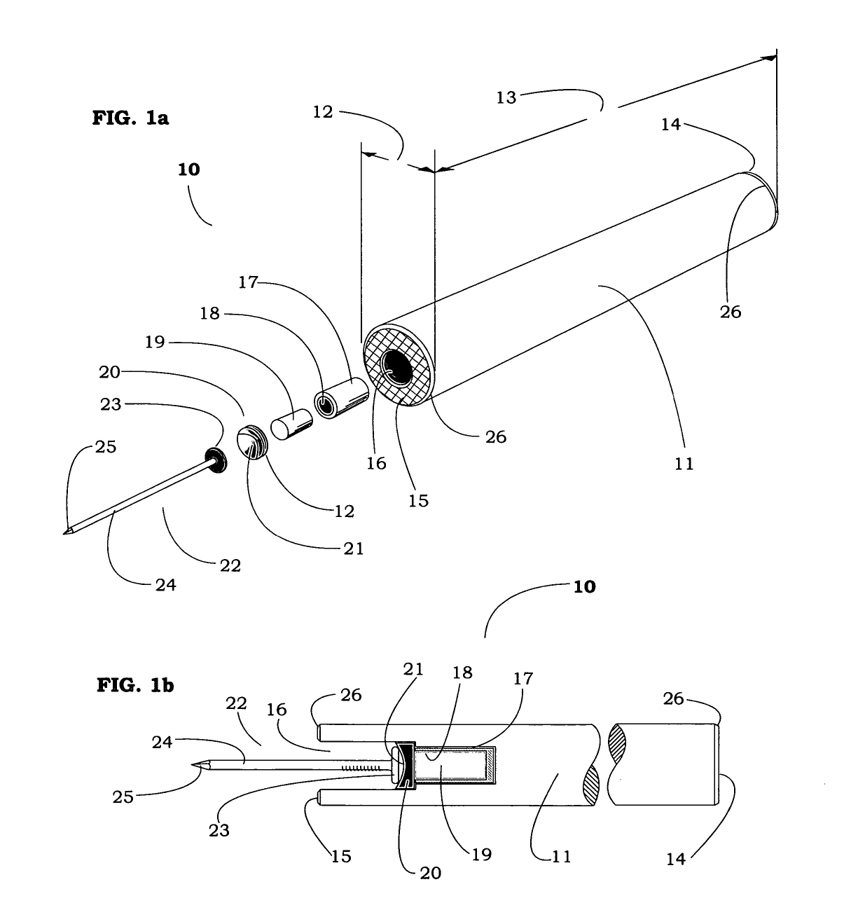

FIG. 1a Shows an exploded perspective view of the subject invention and it's component parts.

FIG. 1b Shows a cut-away view of the subject invention.

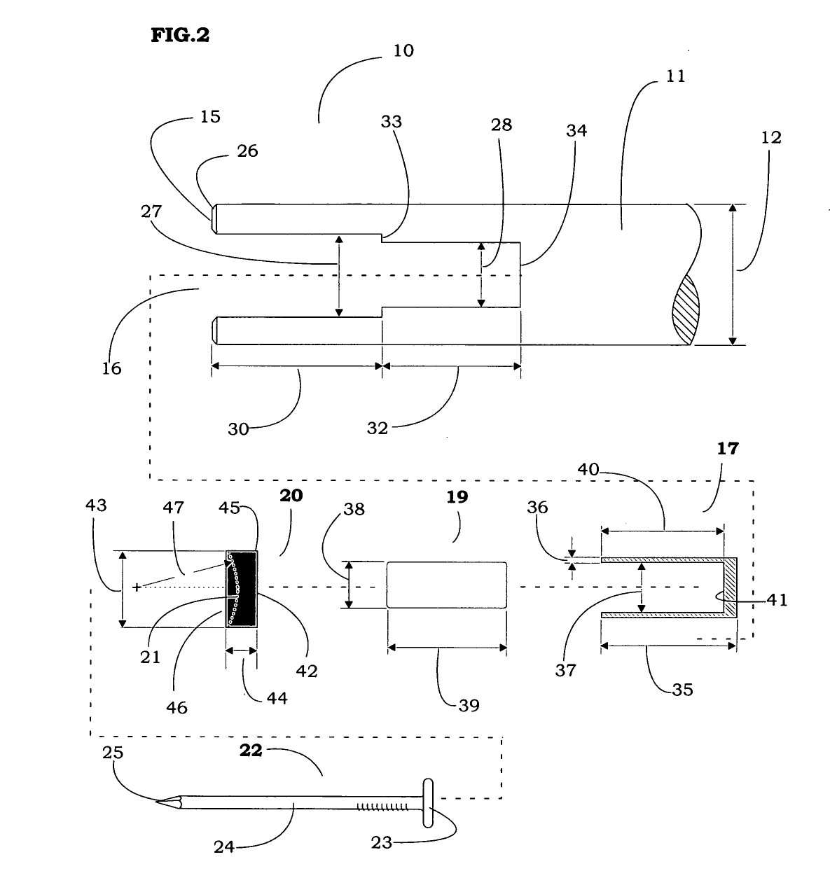

FIG. 2 is a large scale cut away view of the compound bore in the second planar surface of the subject invention.

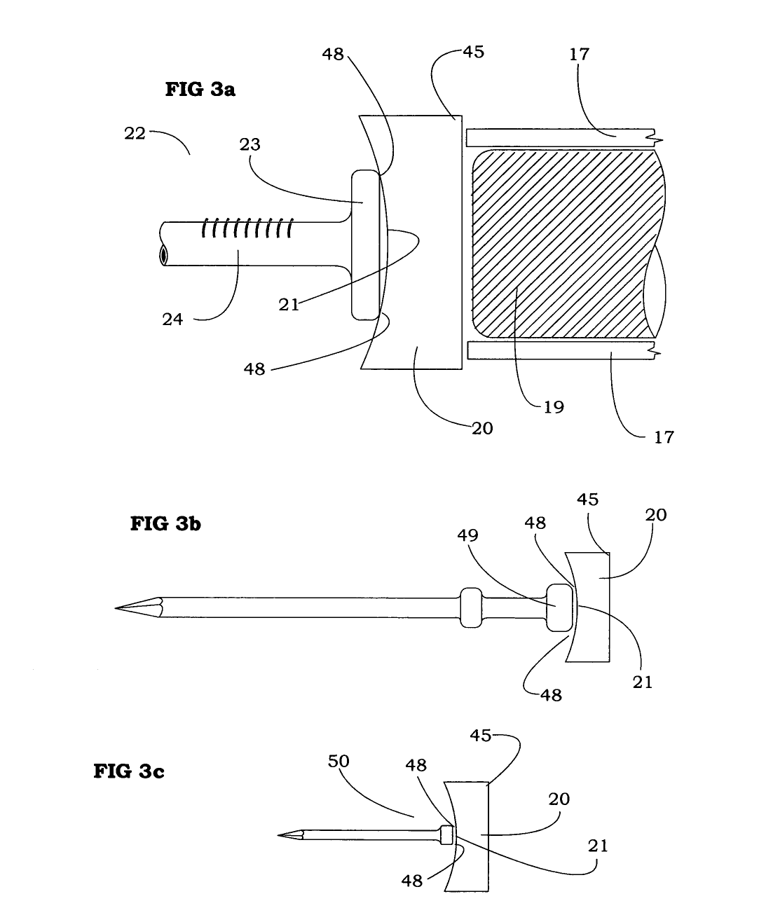

FIGS. 3a, 3b and 3c shows a blowup view of the plug disc, magnet and nail head details.

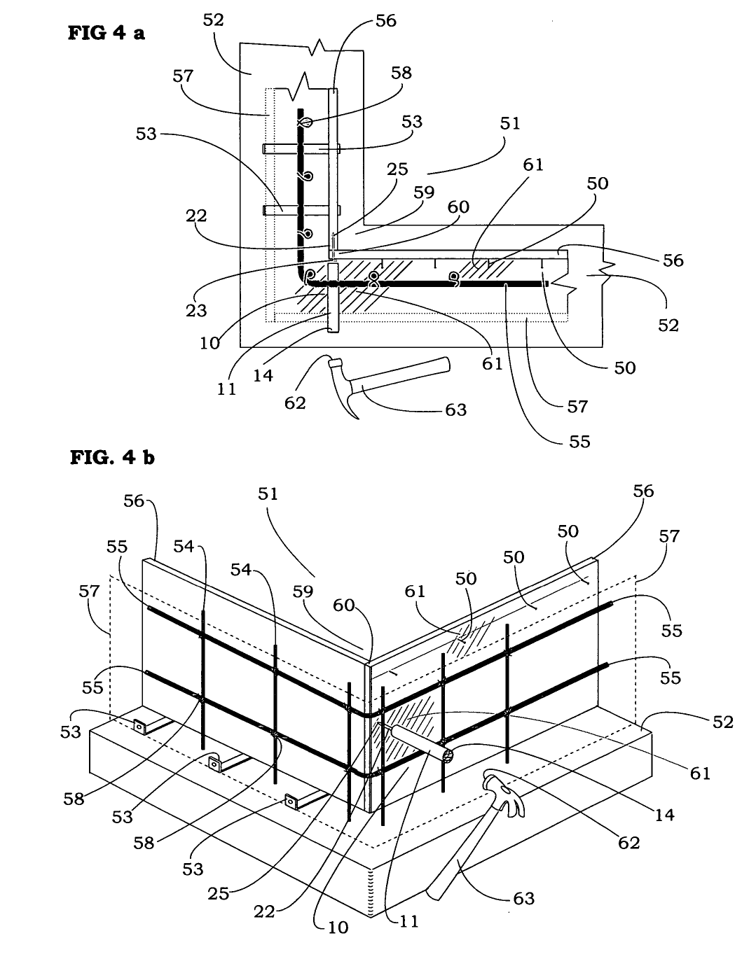

FIGS. 4a and 4b show top and perspective view details of a concrete form for the purpose of explaining how the subject invention would be used.

### DETAILED DESCRIPTION

Referring now to FIGS. 1a and 1b

wherein tool (10) comprises an elongated cylindrical shaped section of hardened steel having a body (11). Body (11) is approximately ¾″ in diameter (12) and 6″ in length (13) and serves the purpose of transmitting force and griping tool (10), body (11) is further defined as having a non slip impact receiving first planer surface (14) at one end of body (11), and a non slip impact receiving second planer surface (15) at the opposite end of body (11). Second planer surface (15) has a compound cylindrical bore (16) extending axially into body (11) from second planer surface (15) and wherein compound bore (16) in second planer surface (15) is provided for the purpose of receiving a shielding sleeve (17). Shielding sleeve (17) is provided with cavity (18) arranged to receive barrel shaped magnet (19) and plug disc (20). Plug disc (20) is provided for the purpose of retaining shielding sleeve (17) and magnet (19) substantially in position inside compound bore (16) of tool (10). Plug disc (20) is also provided for with a concave detail (21). Magnet (19) and concave detail (21) of plug disc (20) keep head (23) and nail shank (24) of nail (22) axially centered in compound bore (16) of body (11) of tool (10); maintaining axial alignment of nail (22) to body (11) as required for positioning nail tip (25) perpendicular to any surface where nail (22) is to be driven while locating and preparing to drive nail (22). Outside diameter (12) of body (11) of tool (10) to have a slight 45 degree chamfer (26) at the point where outside diameter (12) of body (11) falls immediately adjacent to first planar surface (14) and second planar surface (15).

Referring now to FIG. 2

Wherein second planer surface of tool (15) is provided for with compound bore (16). Compound bore (16) being further defined as comprising a major bore (27) and a minor bore (28). Major bore (27) diameter to be approximately 0.375″ with a depth (30) of approximately 1.0″. The purpose of major bore (27) is to receive plug disc (20) nail head (23) and nail (22). Minor bore (28) diameter to be approximately 0.312″ with a depth (32) of approximately 0.750″ measured from shoulder (33) to minor bore (28) bottom (34). The purpose of minor bore (28) is to receive shielding sleeve (17) and magnet (19). Shielding sleeve (17) is to be non-ferrous metallic material provided for the purpose of insulating and reducing magnetic effect between body (11) of tool (10) and magnet (19) allowing a greater magnetic effect from magnet (19) to be directed to plug disc (20) resulting in better retention of nail (23) Of nail (22) by tool (10). Shielding sleeve (17) to have a length (35) of approximately 0.630″; slightly less than depth (32) of minor bore (28), a wall thickness (36) of approximately 0.062″ and an inside diameter (37) of a dimension to allow for snug fit to approximate 0.186″ outside diameter (38) of magnet (19) when magnet (19) is fit inside shielding sleeve (17) in assembly of tool (10) during the manufacturing stage. Magnet (19) provides holding force a required to retain head (23) of nail (22) in position against plug disc (20). Length (39) of magnet (19) to be slightly less than depth (40) of shielding sleeve (17) insuring no compressive forces will be introduced to magnet (19) positioned between back surface (41) of shielding sleeve (17) and back face (42) of plug disc (20) when impact forces are applied to planar surface (14) or (15) of tool (10) and transmitted through body (11) to the opposite planar surface (14) or (15).

Plug disc (20) to be of hardened ferrous metal construction having a diameter (43) of approximately 0.373″ and a thickness (44) of approximately 0.125″, a back face (42), a corner parameter (45) and a front surface (46). Front surface (46) of plug disc (20) is provided for with a spherically concave detail (21) to aid in centering head (23) of nail (22) in plug disc (20) maintaining axial alignment of nail (22) inside major bore (27) of tool (10) when positioning nail (22) for driving. Spherically concave detail (21) to have a radius (47) of approximately 0.419. Plug disc (20) to be positioned substantially inside major bore (27) of compound bore (16) during assembly with corner parameter (45) of plug disc (20) back face (42) seated substantially against shoulder (33). Shoulder (33) further defines the transition point between major bore (27) of compound bore (16) and minor bore (28) of compound bore (16).

Referring now to FIGS. 3a 3b and 3c

FIG. 3 a shows a close up view of the relationship between plug disc (20), magnet (19), and nail (22) wherein positioning of a standard nail head (23) against concave detail (21) of plug disc (20) of tool (10) defines contact point (48) between nail head (23) and concave detail (21) of plug disc (20) as required to keep nail (22) axially oriented and parallel to axial centerline of tool (10) and wherein nail head (23) and plug disc (20) are influenced by magnetic attraction of magnet (19) which retains nail (22) in compound bore (16) of tool (10) in preparation for placement and driving.

FIG. 3b depicts in part the same detail as outlined in FIG. 3a showing how a duplex nail head (49) is accommodated by concave detail (21) of plug disc (20) in tool (10). FIG. 3c outlines the same capability of the axially orienting concave detail (21) as outlined in FIGS. 3a and 3b; when tool (10) is used for holding and positioning a small pour height level nail (50).

Referring now to FIG. 4 a and 4 b

For the purpose of better understanding one of the many situations in which tool (10) is used, FIGS. 4 a and 4 b show a top and perspective view of a pouring form that is used in the fabrication of concrete walls. The following is a typical application for the proposed invention wherein a section of a concrete form (51) is disclosed whose assembly procedure requires the installation of various types of nails required for the fabrication of the form and must be located and driven into parts of the form in which it is either too difficult to position a nail for driving or to restricted an area to swing a common hammer to provide the necessary impacting force for driving a nail.

Concrete form (51) comprises a number of component parts including a footing (52), form ties (53) numerous stands of vertical re-bar (54), horizontal re-bar sections (55), inside form panel (56) an outside form panel (57), (See ghost lines), a plurality of pour height level nails (50) which are placed inside form panels to indicate how much concrete should be poured into the particular form, and a plurality of wire ties (58). Wire ties (58) provide for tying together stands of vertical re-bar (54) and horizontal re-bar sections (55). Although there may be additional components and procedures involved in the construction of a concrete footing (52) and form (51), the above mentioned components will be sufficient for the purposes of explaining the function of the disclosed invention,

The first phase of concrete form (51) construction involves the digging of a trench of sufficient width and depth wherein a concrete footing (52) can be cast in place. For this example, the footing (52) would measure approximately 6″ high and 18″ wide and provide the base for assembly of inside form panel (56) and outside form panel (57). An important part of footing (51) construction is the numerous stands of vertical re-bar (54) that are placed in the footing (52) form, prior to pouring in the concrete. The vertical re-bar (54) is the component that helps to tie footing (52) to the resulting concrete wall. Next, a number of horizontal re-bar sections (55) are positioned and wired to the vertical stands of re-bar (54) with wire ties (58). This cross tie wiring of vertical re-bar (54) and horizontal re-bar (55) sections serves as a integral reinforcing grid inside the resulting concrete wall providing substantially increased strength in the wall after the concrete is fully cured. After the cross tying of the re-bar, the next sequence in the assembly of concrete form (51) requires that form ties (53) be placed at intervals on top surface of the fully cured concrete footing (52). Form ties (53) are designed with geometry to receive the bottom edges of inside form panel (56) and outside form panel (57) and are used to maintain consistent spacing between inside form panel (56) and outside form panel (57) during assembly of concrete form (51). The following sequence of concrete form (51) assembly requires that the inside form panel (56) and outside form panel (57) be positioned and secured on top surface of footing (52). It is this stage of construction where tool (10) will be required wherein, inside form panel (56) is set into form tie (53) on top of footing (52) and secured. At each inside form panel (56) corner junction (59) of form (51) an overlap (60) is required for fastening one inside form panel (56) to the adjacent inside form panel (56) which generates corner (59).

As vertical rebar (54) and horizontal rebar (55) must already be set and tied in position as outlined earlier, access to overlap (60) of the two adjoining inside panels (56) where nailing fasteners are to be placed is normally restricted (61) to the point where common hammer (63) cannot be manipulated. For proper fastening of corner (59) however, a plurality of nails (22) must be placed along vertical edge of overlapped (60) portion of inside panel (56) and driven into adjacent inside panel (56). This is a crucial point of attachment and for accurate positioning, often requires nail (22) to be maneuvered in and behind grid formed by vertical re-bar (54) and horizontal re-bar (55), prior to being driven to proper depth. Due to the necessity of placing fasteners in restricted area (61), tool (10) is utilized in the following manner wherein (referring again to FIG. 1) head (23) of nail (22) is placed into compound bore (16) of tool (10). Nail (22) is held in the proper, oriented position by the magnetic retention of head (23) of nail (22) within concave detail (21) of plug disc (20). (referring back again to FIG. 4 b) Tool (10) and nail (22) are then placed through restricted area (61) positioning tip (25) of nail (22) substantially against surface on inside form panel (56). Extended length of body (11) of tool (10) positions first planar surface (14) end of tool (10) outside of restricted area (61), clear and accessible for impacting with hammer (63), wherein a few taps with head (62) of hammer (63) on first planar end (14) of tool (10) will partially drive tip (25) of nail (22) into overlap (60) portion of inside panel (56).

Tool (10) can then be withdrawn back through restricted area (61), turned end for end placing first planar end (14) of tool (10) back through restricted area (61) against nail head (23) wherein nail (22) can then be driven to maximum depth as required by impacting second planar surface (15) with head (62) of hammer (63). Level nails (50) are also placed into the surface of inside form panel (56) at this time. As their positioning will normally be in close proximity of restricted access areas similar to area (61), the same procedure for placing and driving level nails (50) is implemented.

The forgoing describes a simple yet rugged tool that can be used with a common hammer, for placing nails into difficult to access areas, wherein the tool has no moving parts; allowing for trouble free use in very harsh and dirt contaminated areas. The tool as disclosed is versatile in that it will accommodate a number of nail sizes and head configurations, it will hold the nail in the proper oriented position for placing and provides extended length allowing for placing and driving nails in hard to access areas where either positioning a nail for driving, or swinging a hammer to impact a nail directly might be difficult.

It should be noted that the forgoing description of the preferred embodiment of the invention has been presented for the purpose of illustration and description. It is not intended to be exhaustive or limit the invention to the precise form disclosed. Many variations or modifications are possible under the above teaching. It is intended that the scope of the invention be limited not by this detailed description but rather by the claims appended hereto.

I claim:

1. A nail positioning and driving device for use with a common hammer comprising in combination an elongated cylindrically shaped section of hardened steel with a first planar surface at one end and a second planar surface at the opposite end wherein said second planer surface on said elongated cylindrically shaped section of hardened steel provides means for a non slip impact receiving surface wherein a cylindrical bore extending longitudinally into said second planar surface provides means to accommodate a magnetic component, a means for retaining said magnetic component, and at least a portion of the length of said nail; and wherein said first planar surface of said opposite end of said elongated cylindrically shaped section provides for a non slip impact receiving surface

2. The combination of claim 1 wherein said means for retaining said magnetic component inside said cylindrical bore comprises a small steel disc having a front face, a back face, and a diameter sized for interference fit inside said cylindrical bore and wherein geometry on at least surface of said steel disc provides concave detail for self centering of a nail head and axial alignment of said nail to said cylindrical bore.

3. The combination of claim 2 wherein the diameter of said magnetic component is substantially encapsulated by a non-ferrous shielding sleeve

4. The nail starting and driving device of claim 3 wherein said cylindrical bore comprises a major diameter and a minor diameter

5. A steel bar of elongated geometry; having a diameter to length ratio of approximately 1:8 wherein one end of said steel bar is placed against a nail head and the opposite end is impacted with a common hammer.

6. The steel bar of claim 5 wherein as least one end of said elongated geometry is provided for with non mechanical means for retaining and maintaining said nail in axial alignment with longitudinal center line of said elongated geometry while tip of said nail is being positioned on surface to be nailed.

7. A hardened steel bar of extended length having no moving parts; used for driving nails; having a diameter between ½″ and 1″ and a length between 3″ and 12″ transmits impact force through said extended length of said metal bar to the head portion of said nail when struck on one end with a common hammer

8. The hardened steel bar of claim 7 provided with non mechanical means on at least one end for holding a plurality of said nail types and sizes at proper orientation for being driven into work surface.
